(19) United States
(12) Patent Application Publication
(10) Pub. No.: US 2015/0329267 A1
(43) Pub. Date: Nov. 19, 2015

(54) CONTAINER FOR FOOD PRODUCTS, A METHOD FOR MANUFACTURING OF A CONTAINER, METHOD FOR DETECTING INTERNAL GAS AND A PRODUCTION SYSTEM FOR FILLING CONTAINERS

(71) Applicant: Å&R CARTON LUND AB, Lund (SE)

(72) Inventors: Simon HOLKA, Staffanstorp (SE); Lennart AVELING, Hollviken (SE)

(21) Appl. No.: 14/654,330

(22) PCT Filed: Dec. 19, 2013
(86) PCT No.: PCT/SE2013/051580

§ 371 Date: Jun. 19, 2015

(30) Foreign Application Priority Data
Dec. 21, 2012 (SE) 1251491-5

(51) Int. Cl. B65D 81/30; B65B 31/04; G01N 21/59; B65B 51/22; B31B 1/72; B65D 25/54; B65B 57/00

(52) U.S. Cl. CPC B65D 81/30; B65D 25/54; B65B 31/04; B65B 57/00; B65B 51/227; B31B 1/72; G01N 21/59; B31B 2201/6073; G01N 2201/06113

(57) ABSTRACT

The invention concerns a container for food products or other sensitive products, said container being made of a material that intends to provide the container with gas-tight properties and that comprises a layer that exhibits no or only a low translucence to light. The invention is characterized in that at least one opening is provided in the layer with no or low light translucence such as to allow light for non-destructive detection of gas inside the container to enter and exit through said at least one opening. The invention also concerns a method for detecting gas inside a sealed container of the above type and a method for manufacturing of a container of the above type from blanks of a cardboard based material. The invention also concerns a production system comprising an apparatus for filling containers of the above type with a product and an apparatus for sealing the filled containers, wherein the system further comprises an apparatus for carrying out the method for detecting gas inside the sealed container.

### TECHNICAL FIELD

This invention relates to a container for food products or other sensitive products, said container being made of a material that intends to provide the container with gas-tight properties and that comprises a layer that exhibits no or only a low translucence to light. The invention is characterized in that at least one opening is provided in the layer with no or low light translucence such as to allow light for non-destructive detection of gas inside the container to enter and exit through said at least one opening. The invention also concerns a method for detecting gas inside a sealed container of the above type and a method for manufacturing of a container of the above type from blanks of a cardboard based material. The invention also concerns a production system comprising an apparatus for filling containers of the above type with a product and an apparatus for sealing the filled containers, wherein the system further comprises an apparatus for carrying out the method for detecting gas inside the sealed container.

### BACKGROUND OF THE INVENTION

Many food products are packaged in sealed gas-tight containers with a controlled internal atmosphere as to protect the food stuff and prolong shelf-life etc. Typically, a headspace of the food container, i.e. the space inside the container above the food and below the seal, is evacuated or contains close to 100% nitrogen gas to avoid the presence of oxygen gas.

For quality and safety reasons it is sometimes necessary to check the status of the internal atmosphere that is in contact with the food product. Traditionally, the methods for this purpose involve puncturing the container which leads to waste of both products and packages.

In an alternative method described in WO2010/145892 a laser source is used to direct light through the container wall and into (the headspace of) the package. Scattered light enters the package and interacts with gas inside the package. By measuring, in a position outside of the package, an absorption signal of the light that exits the package it is possible to measure e.g. the concentration of oxygen gas inside the package without puncturing it. Only the light, incoming and outgoing, needs to pass through the walls or lid of the package. The package may appear non-transparent but it is sufficient that the package is translucent to a certain wavelength range of the laser light.

The method of WO2010/145892 is very useful in many applications but is not applicable to containers made of a material that is not translucent to light, such as a multilayer laminate where an aluminium foil forms one of the layers. Container materials of this type include e.g. cardboard laminates used for food in dry powder form.

There is thus a need for improvements with regard to methods for checking the status of the internal atmosphere in containers made of a material that is not translucent to light.

### SUMMARY OF THE INVENTION

The invention concerns a container for food products or other sensitive products, said container being made of a material that intends to provide the container with gas-tight properties and that comprises a layer that exhibits no or only a low translucence to light.

The invention is characterized in that at least one opening is provided in the layer with no or low light translucence, such as to allow light for non-destructive detection of gas inside the container to enter and exit through said at least one opening.

Thereby, laser light can be allowed to enter the (headspace of the) container, interact with the gas present (if any) and exit via the same or another opening and be detected and analyzed outside of the container such as to check the content and concentration of the gas present. The technique described in WO2010/145892 is applicable but also other techniques can be used as the light does not have to be scattered when passing into the container.

Typically, the container has a bottom, walls and a sealing membrane or sealed lid on top.

The term gas-tight properties is used in the common-sense meaning, i.e. it means as gas-tight as reasonably achievable. No material is 100% gas-tight over time.

In an embodiment of the invention the opening is covered with a covering material that has a high translucence to light. The covering material may thus be transparent to light.

Preferably, the covering material forms gas barrier and/or the at least one opening is sufficiently small so as to avoid that the overall gas-tightness of the container is significantly reduced. Thus, a container that has a small opening covered with e.g. a layer of plastic material can still be “gas-tight”.

Using a covering material makes it possible to use (a) larger opening(s). In general terms, an opening with a side/diameter of around 0.1 mm can be used without covering material in a container having a volume of 1 liter. Such an opening may be too small to allow enough light to exit for the analysis of the internal gas atmosphere. Openings/windows in the size 2×2 mm or 4×4 mm may be sufficiently large for some gas detection techniques and may be covered by regular container multilayer plastic material depending on the type of material and the size of the container.

An opening size of at least 4×20 mm is required for some light reflection techniques. Such large openings need to be covered with a special material, i.e. a material with special gas permeability and/or special thickness. Using a special plastic material over the entire container structure would be too costly. It is possible to locally weld the special plastic material over the openings but such an additional production step is also costly. A further method is described below.

Preferably, at least a part of the at least one opening is positioned in an upper position of the container in a region intended to contain an internal gas atmosphere above a product placed in the container. Thereby, light can be directed into the headspace when a filled container is placed in a normal position with its bottom facing downwards.

Preferably, the at least one opening is arranged in a wall section of the container. Alternatively, or as a complement, an opening can be placed in the sealing lid.

In a typical embodiment of the invention, the container is made of multilayer structure comprising a layer of aluminium, wherein the at least one opening is arranged in the aluminium layer. The aluminium layer preferably has a thickness in the range 4-40 μm. This makes the aluminium layer gas-tight and non-translucent to light.

Such a multilayer structure preferably also comprises a layer of a weldable plastic material that also forms the covering layer. The opening(s) can thus be made in the aluminium layer before laminating the aluminium and plastic layers to each other, during which process the covering layer will form without any special step. The covering layer can alternatively be formed by attaching a tape or similar to the laminate after having arranged the opening in the entire multilayer structure.

Preferably, the multilayer structure also comprises a layer of a cardboard material that works as a supporting layer.

The invention also concerns a method for determining a gas content in a container according to what is described above. This method comprises the steps of directing light through the at least one opening into the container, and detecting light that exits from the container through the at least opening.

In variants of the inventive method the following may be applied:
the light directed into the container is emitted from a laser source,
the absorption of the light that exits the container is measured,
the container comprises more than one opening and the light enters the container through a first opening and exits the container through a second opening.

The invention also concerns a method for manufacturing of a container according to above from blanks of a cardboard based material, said method comprising the steps of:
providing a substantially plane blank of a multilayer material comprising a supporting cardboard layer, a weldable layer and a gas-tight layer,
arranging, in at least the cardboard layer, at least one cut-out,
forming a rounded container body from the blank by bending the blank such as to connect said first edge with an opposite edge of the blank wherein a joint is formed along the connected edges,
applying a gas-tight and translucent strip of material in such a way that the opening is covered by the material strip.

The invention also concerns a production system comprising i) an apparatus for filling containers according to above with a product and ii) an apparatus for sealing the filled containers, wherein the system further comprises iii) an apparatus for carrying out the method for detecting gas inside the sealed container.

### BRIEF DESCRIPTION OF DRAWINGS

In the description of the invention given below reference is made to the following figures, in which:

FIG. 1 shows, in a schematic view, a container according to an embodiment of the invention,

FIG. 2 shows, in a schematic view, the principle of a first embodiment of the inventive gas detection method applied to a container similar to what is shown in FIG. 1,

FIG. 3 shows, in a schematic view, the principle of a second embodiment of the inventive gas detection method applied to a container similar to what is shown in FIG. 1, and

FIGS. 4a and 4b show examples of a blank provided with a cut-out/opening.

### DESCRIPTION OF EXAMPLE EMBODIMENTS OF THE INVENTION

Equipment for manufacturing of containers from blanks of a cardboard based material is described in e.g. EP0074343. Such equipment normally includes a container body forming unit where an initially cylindrical container body is formed from a substantially plane blank of a multilayer material comprising at least a supporting cardboard layer and a weldable, plastic layer. In a welding unit, an end closure, a bottom, is applied to the inside of the container body by inducing welding energy and melting the weldable layer. Such a welded joint is well known to be capable of being gas tight. After welding the bottom edge of the container body is normally processed in an edge shaping unit where the edge typically is folded, heated and curled to provide stability and a more appealing appearance. Also the body blank may be welded together as to form the cylindrical container body, but welding of the end closure is usually a more complex process step.

Often both the container body and the end closure form multilayer structures where a weldable plastic film is applied to the inside of the cardboard based lid and container. In particular for food products, the layer structure usually includes a layer of aluminium arranged between the cardboard and the plastic layer. Typically, a high frequency current energy is induced in the aluminium layer, which foil thereby gets heated and in turn melts the plastic film. Automated equipment of this type further comprises transporting means configured to transport a flow of containers from the container body forming unit to the welding unit and further downstream in the equipment.

Equipment for filling the containers and for sealing and closing the filled containers can be arranged in connection to the container manufacturing equipment.

Instead of using aluminium for the gas-tight layer it is possible to use a metalized film. Such a film can be adapted to exhibit a sufficient light translucence for detection purposes.

The equipment and material described above are suitable for the container of the present invention. By providing one or both of the edges of the body blank with one or several cut-outs, one or several openings will form when the two edges are joined to each other, i.e. when the rounded container body is formed. By covering the joint or seam and the openings formed between the edges with a strip of material that exhibits gas-barrier properties and that is translucent and maybe also transparent to (laser) light, one or several useful windows (for later detection of gas inside the container) are formed along the joint. This strip of material can be a tape, i.e. provided with an adhesive, and/or be welded to the two edges as to form a gas tight joint.

The remaining manufacturing of the container can follow the conventional method.

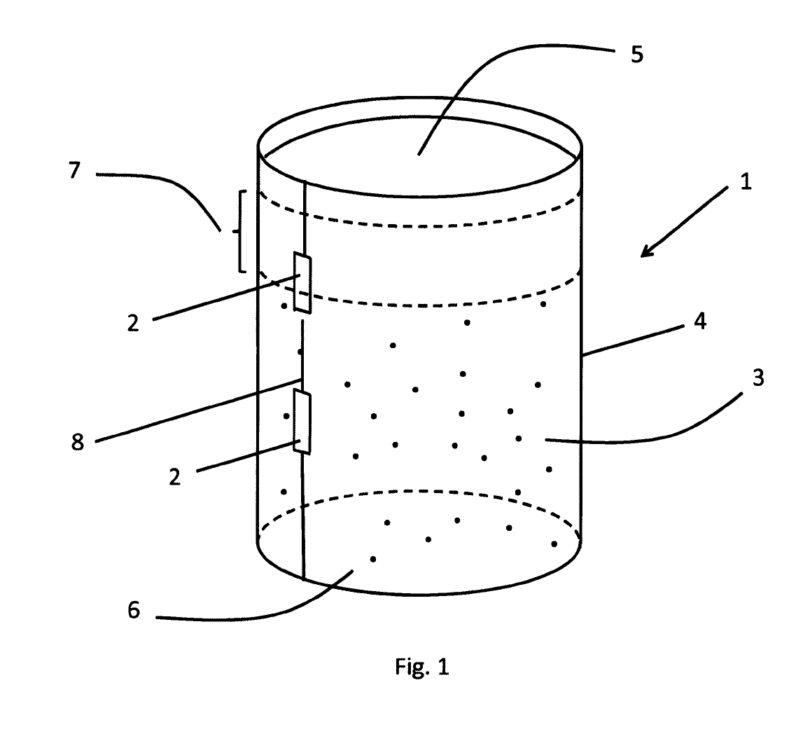

A schematic view of a container 1 of the type described above is shown in FIG. 1. The container 1 has a rounded wall section 4 formed by bending a blank as to form a joint 8 between edges of the wall section 4. Cut-outs have been punched out at both edges such that oblong openings 2 are formed along the joint 8. A gas-tight and translucent strip of material (not shown) has been applied along the joint 8 and covers the openings 2. The container 1 has further a bottom closure 6 and has been filled with food product powder 3. A sealing membrane 5 seals an upper part of the container 1. A headspace 7 is formed between the powder 3 and the sealing membrane 5.

The material forming the wall section 4 and the bottom 6 is a multilayer material comprising a supporting cardboard layer, a weldable layer and an aluminium layer. The aluminium layer or foil has typically a thickness of 6.35 or 9 μm. Al-foils with larger thickness are sometimes used, e.g. 18 or 35-38 μm. Generally, the Al-layer can be said to a have thickness of 4-40 μm.

A method for manufacturing of the container 1 from blanks of a cardboard based material comprises the steps of:
providing a substantially plane blank of a multilayer material comprising a supporting cardboard layer, a weldable layer and a gas-tight layer,
arranging, in at least the cardboard layer, at least one cut-out,
forming a rounded container body from the blank by bending the blank such as to connect a first edge with an opposite edge of the blank wherein a joint is formed along the connected edges,
applying a gas-tight and translucent material in such a way that the opening is covered by the gas-tight and translucent material.

The order of the method steps may be varied to some extent. The order presented above is useful for the method described further above where the cut-out is arranged also in the weldable and the gas-tight layer and where a strip of material, for the purpose of covering the joint or seam and the openings formed between the edges, is applied after having formed the container body. In this method: i) the at least one cut-out is arranged at a first edge of the blank; ii) an opening is formed at the at least one cut-out when forming the rounded container body, and iii) the gas-tight and translucent material is a strip of material that is applied along the joint along the connected edges.

However, the cut-out may alternatively be arranged only in the cardboard and the gas-tight (aluminium) layers before applying the weldable layer in the multilayer material. A weldable (and gas-tight and translucent) layer can then be applied onto the cardboard and the aluminium layers so as to cover the cut-out/opening that in this case may or may not be placed at an edge of the blank. Further, the “edge” may in this case be an intended edge if the blank has not yet been cut out from a larger multilayer material. The particular part or strip of the weldable layer that covers the cut-out/opening can be made of a particular material with enhanced capability of being gas-tight. This means that only certain parts or strips of the weldable layer need to be made of this particular (and probably more expensive) material. Thus, in this case the step of “applying a gas-tight and translucent material . . . ” is performed before the step of “forming a rounded container body from the blank by bending . . . ”. This variant of the method is also described further below.

In a further alternative method, the cut-out may be arranged only in the cardboard layer before applying any of the gas-tight or the weldable layers in the multilayer material. A gas-tight layer in the form of metalized film (that is sufficiently transparent to light) can then be applied onto the cardboard such as to cover the cut-out/opening. A weldable layer (which in this case does not have to be gas-tight) can then be applied onto the cardboard and the metalized layers so as to (together with the gas-tight layer) cover the cut-out/opening that as in the alternative method above may or may not be placed at an edge of the blank. Further, the “edge” may in this case be an intended edge if the blank has not yet been cut out from a larger piece material. Thus, also in this case the step of “applying a gas-tight and translucent material . . . ” is performed before the step of “forming a rounded container body from the blank by bending . . . ”.

The manufacturing method may also comprise one or several of the following steps:
welding the material strip to the edges,
fastening an end closure to the container body by generating an inductive welding energy for melting of the weldable layer; and
transporting: a flow of body blanks to a container body forming unit; a flow of container bodies from the container body forming unit to a welding unit; and a flow of container bodies provided with end closures from the welding unit.

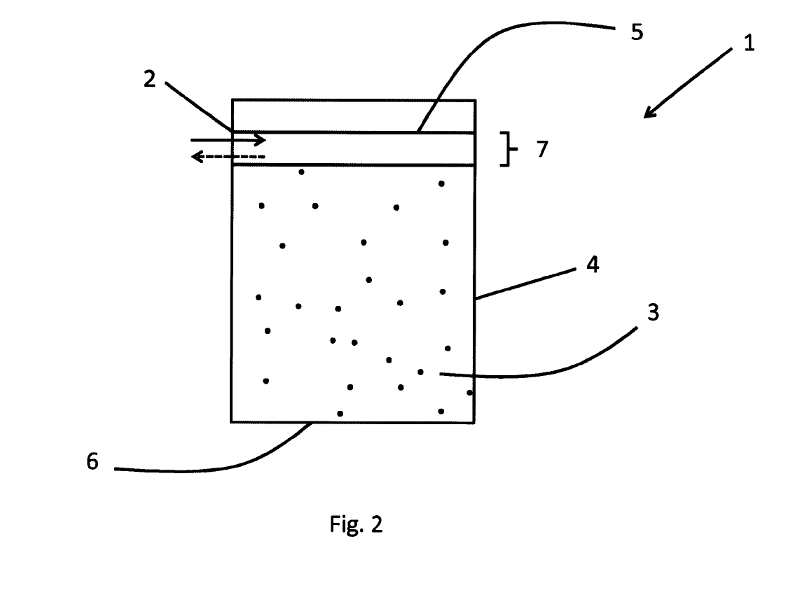

FIG. 2 shows, in a schematic view, the principle of a first gas detection method applied to a container similar to what is shown in FIG. 1. Light emitted from a laser source is directed through the opening 2 into the headspace 7 of the filled and sealed container 1 (solid arrow). Scattered light exits the container 1 via the same window 2 (dashed arrow) and can be detected and analyzed. This method is suitable if the opening 2 is covered with a material that scatters the incoming light, i.e. if the covering material is translucent but not transparent to the incoming light.

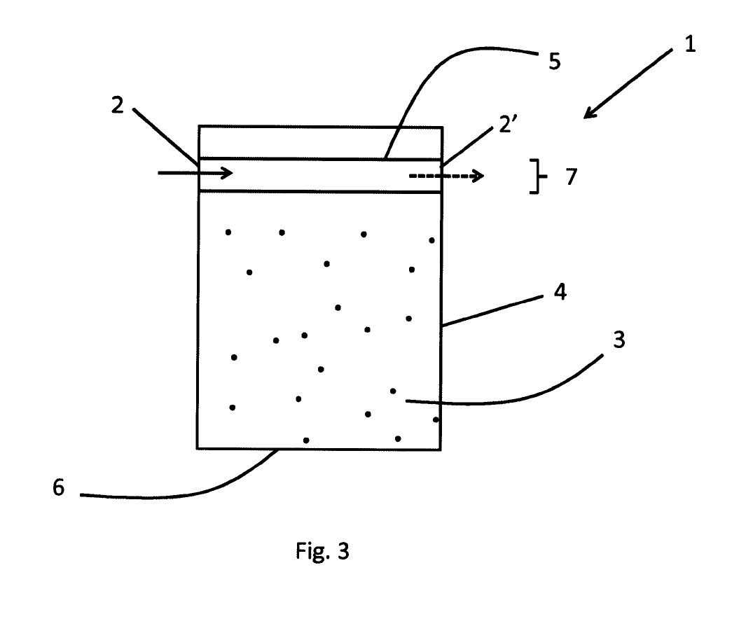

FIG. 3 shows, in a schematic view, the principle of a second gas detection method applied to a container similar to what is shown in FIG. 1, but in this example the container 1 also has a second window 2′. Light emitted from a laser source is directed through the opening 2 into the headspace 7 of the filled and sealed container 1 (solid arrow). Light propagates through the headspace 7 in the same direction and exits the container 1 via the second window 2′ (dashed arrow) and can be detected and analyzed. This method is suitable if the opening 2 is covered with a material that is transparent to the incoming light. To improve the sensitivity of the method the light exiting the second window 2′ can be reflected back towards the container 1 such as to pass through the head space once again and exit through the first opening 2 and then detected and analyzed.

How to detect and analyze the light, and how to determine the content of gas from such an analysis, is known as such to the person skilled in the art.

The method for detecting gas inside a sealed container of the type discussed here can be made “in-line”, i.e. it can form part of the production line where the containers e.g. are filled and sealed (under an atmosphere of protection gas such as nitrogen), or it can be made “off-line”, i.e. separate from the production line. If arranged “in-line” it can be arranged so that containers that e.g. contains too much oxygen are removed or marked in some way.

Thus, a production system comprising e.g. an apparatus for filling containers of the above type with a product and an apparatus for sealing the filled containers preferably also comprises an apparatus for carrying out the method for detecting gas inside the sealed container. Such a system preferably also comprises means for sorting out or marking containers that exhibits an abnormal gas content. The system may also comprise an apparatus for manufacturing the containers and an apparatus for applying an outer lid to the containers.

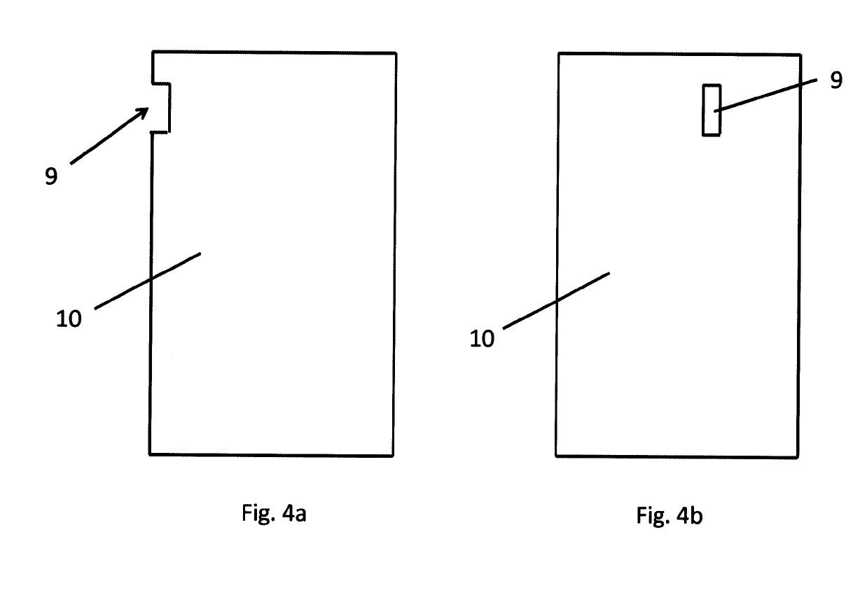

FIGS. 4a and 4b show examples of a blank 10 provided with a cut-out 9. In FIG. 4a the cut-out is placed at an edge of the blank 10. In this case the opening 2 is thus formed when forming the container 1, i.e. when bending the blank 10 to form a container similar to what is shown in FIG. 1.

In FIG. 4b the cut-out 9 is not positioned at the edge. This is possible when it is not intended to cover the cut-outs/openings with a (narrow) strip of material that also is intended to be used for joining the edges of the blank/container. Accordingly, positioning of the cut-out 9 as shown in FIG. 4b works fine if the cut-out/opening is to be covered by a gas-tight layer forming part of the multilayer structure. As described above this covering layer can be a metalized film (in which case the cut-out 9 is made only in the cardboard layer and where the metalized film functions as a gas-tight layer in the multilayered structure) or a weldable layer (in which case the cut-out 9 is made in both the cardboard layer and the gas-tight layer, which may be an aluminium layer, and where the weldable layer preferably contains zones or strips of particularly gas-tight material positioned such as to match the positions of the cut-outs/openings so that the weldable only partially needs to be made of such a particular material).

The above described methods for manufacturing the container 1 provide for a cost-effective production method where it is not needed to apply separate pieces of material only for the purpose of covering the openings.

The invention is not limited by the embodiments described above but can be modified in various ways within the scope of the claims.

The material covering the opening can form part of one of the laminated layers in a laminated multilayer structure. Typically, this would be the layer of weldable plastics in a cardboard-aluminium-plastics structure. To improve the gas barrier at the openings, the plastic material used can be prepared with strips of a material that forms a better gas barrier than normal weldable plastics, wherein the orientation and distance between the strips are adapted so that the strip covers the openings when the container is produced. For instance, this strip can be positioned in the laminating material so that it covers the (joint and) openings when a container is formed from a plane blank as described above. Preferably, the strip protrudes from one of the edges of the blank such as to overlap the other edge when the edges are connected. The gas barrier material strip can alternatively be formed of a separate piece of material applied onto the container such as to cover the at least one opening and, if appropriate, also the joint.

Generally, it is an advantage if the material(s) that cover the opening forms a barrier for UV-light (but still allows light for gas detection to pass) since the content of the container may be sensitive to UV-light.

Some container assemblies comprise an inner, gas-tight and usually flexible container and an outer supporting (cardboard) container. To make use of the gas detecting method the covered opening discussed above should be placed in the inner container. A further opening, that not necessarily have to be covered, can be made in the outer container in a proper position to allow detection light to reach the opening of the inner container.

1. A container for food products or other sensitive products, comprising:
a material configured to provide the container with gas-tight properties;
layer that exhibits no or only a low translucence to light; and
at least one opening defined in the layer configured to allow light for non-destructive detection of gas inside the container to enter and exit through said at least one opening.

2. The container according to claim 1, wherein
the opening is covered with a covering material that has a high translucence to light.

3. The container according to claim 1, wherein
at least a part of the at least one opening is positioned in an upper position of the container in a region intended to contain an internal gas atmosphere above a product placed in the container.

4. The container according to claim 3, wherein
the at least one opening is arranged in a wall section of the container.

5. The container according to claim 2,
wherein the at least one opening has a width/length or diameter in the range 1-40 mm, preferably in the range 2-20 mm.

6. The container according to claim 1,
wherein the container is made of a multilayer structure comprising a layer of aluminium, wherein the at least one opening is arranged in the aluminium layer.

7. The container according to claim 6,
wherein the aluminium layer has a thickness in the range 4-40 μm.

8. The container according to claim 6,
wherein the multilayer structure comprises a layer of a weldable plastic material.

9. The container according to claim 2,
wherein the weldable plastic layer also forms the covering material.

10. The container according to claim 6,
wherein the multilayer structure comprises a layer of a cardboard material.

11. The container according to claim 10,
wherein the at least one opening is arranged also in the cardboard material.

12. The container according to claim 2,
wherein the covering material is formed of a separate piece of material applied onto the container around the at least one opening.

13. The container according to claim 1,
wherein the container contains a product and is sealed.

14. A method for manufacturing of the container according to claim 1 from blanks of a cardboard based material, said method comprising the steps of:
providing a substantially plane blank of a multilayer material comprising a supporting cardboard layer, a weldable layer and a gas-tight layer;
arranging, in at least the cardboard layer, at least one cut-out;
forming a rounded container body from the blank by bending the blank such as to connect said first edge with an opposite edge of the blank wherein a joint is formed along the connected edges; and
applying a gas-tight and translucent material in such a way that the opening is covered by the gas-tight and translucent material.

15. The method according to claim 14, wherein the at least one cut-out is arranged at a first edge of the blank.

16. The method according to claim 14, wherein an opening is formed at the at least one cut-out when forming the rounded container body.

17. The method according to claim 14, wherein the gas-tight and translucent strip of material is applied along the joint along the connected edges.

18. The method according to claim 14, wherein the gas-tight layer is an aluminium layer, wherein the cut-out is arranged in the cardboard and the aluminium layers before applying the weldable layer in the multilayer material, wherein the weldable layer is a gas-tight and translucent layer and is applied onto the cardboard and the aluminium layers so as to cover the cut-out/opening.

19. The method according to claim 14, wherein the gas-tight layer is a metalized film that is at least partly transparent to light, wherein the cut-out is arranged in the cardboard layer before applying the gas-tight layer or the weldable layer in the multilayer material, wherein the gas-tight layer is applied onto the cardboard layer so as to cover the cut-out/opening.

20. The method according to claim 14, further comprising
welding the material strip to the edges,

21. The method according to claim 14, further comprising
fastening an end closure to the container body by generating an inductive welding energy for melting of the weldable layer.

22. The method according to claims 14, further comprising
transporting a flow of body blanks to a container body forming unit, a flow of container bodies from the container body forming unit to a welding unit, and a flow of container bodies provided with end closures from the welding unit.

23. A method for detecting gas inside a sealed container according to claim 1, said method comprising the steps of
directing light through the at least one opening into the container; and
detecting light that exits from the container through the at least opening.

24. The method according to claim 23, wherein the light directed into the container is emitted from a laser source.

25. The method according to claim 23, wherein the absorption of the light that exits the container is measured.

26. The method according to claim 23, wherein the container comprises more than one opening and wherein the light enters the container through a first opening and exits the container through a second opening.

27. A production system comprising an apparatus for filling containers according to claim 1 with a product and an apparatus for sealing the filled containers, wherein the system further comprises an apparatus for carrying out the method for detecting gas inside the sealed container according to claim 23.

28. The production system according to claim 27, wherein the system further comprises means for sorting out or marking containers that exhibits an abnormal gas content.
